(19) United States
(12) Patent Application Publication
(10) Pub. No.: US 2017/0068528 A1
(43) Pub. Date: Mar. 9, 2017

(54) Method for Configuring and Managing Software for an Electronic Device

(71) Applicant: Thomas Craig Carnevale, Plainfield, IL (US)

(72) Inventor: Thomas Craig Carnevale, Plainfield, IL (US)

(21) Appl. No.: 15/340,205

(22) Filed: Nov. 1, 2016

Related U.S. Application Data
(63) Continuation-in-part of application No. 14/596,474, filed on Jan. 14, 2015.
Application No. 14/596,474 is a continuation-in-part of application No. 14/801,565, filed on Jul. 16, 2015.
(60) Provisional application No. 62/249,451, filed on Nov. 2, 2015.
(60) Provisional application No. 62/249,454, filed on Nov. 2, 2015.

(51) Int. Cl. G06F 9/445; G06F 3/0482; G06F 3/0481

(52) U.S. Cl. CPC G06F 8/61; G06F 3/04817; G06F 3/0482

(57) ABSTRACT

A method for configuring and managing software for an electronic device provides a means for registering an electronic device with a remote server. The electronic device includes at least one unique identifier that may be associated with input personal user identification (ID) information in order to register the electronic device. The remote server includes a database with a plurality of device identifiers and a plurality of software packages. The unique identifier is located among the plurality of device identifiers during registration and is associated to the personal user ID information. After the electronic device has been registered on the remote server, a selected software package from the plurality of software packages may be downloaded to the electronic device. The selected software package is then sent from the remote server to the electronic device.

The current application claims a priority to the U.S. Provisional Patent application Ser. No. 62/249,451 filed on Nov. 2, 2015.

### FIELD OF THE INVENTION

The present invention relates generally to a method for registering and managing various aspects of an electronic device. More specifically, the present invention is a method for configuring and managing software for an electronic device such as, but not limited to, a network video recorder (NVR).

### BACKGROUND OF THE INVENTION

A common step after purchasing a new electronic device is to register the device with the manufacturer. Registration offers various benefits for the user including verification that the device is authentic as well as continued software and technical support for the device from the manufacturer throughout the life of the device. Software must often be downloaded to and installed on the device in order to ensure that the device is able to function to its full capacity. For example, a network video recorder (NVR) requires video management software (VMS) that is used to view and compile videos from multiple cameras, record and store video footage to a storage device, and provide a user interface through which a user is able to access and interact with the NVR.

The present invention is a method for configuring and managing software for an electronic device. The method provides a means for registering an electronic device with a manufacturer after purchase. A unique identifier of the electronic identifier is identified on a remote server that hosts a database containing multiple device identifiers (for all devices from the manufacturer) as well as software that may be downloaded for use with the electronic device. If the unique identifier is found in the database, the unique identifier is associated to personal user identification (ID) information provided by the user in order to complete the registration process. After registration of the electronic device, the user is provided with multiple software packages that may be downloaded to the electronic device for use. A selected software package is then downloaded to the electronic device for use. The present invention relates generally to NVRs and VMS that may be installed onto and used with NVRs. However, the present invention has applications relating to other electronic devices as well.

### BRIEF DESCRIPTION OF THE DRAWINGS

FIG. 1 is a flowchart detailing the overall process that is followed by the present invention.

FIG. 2 is a flowchart detailing a secondary process that is followed by the present invention.

FIG. 3 is a flowchart detailing a secondary process that is followed by the present invention.

FIG. 4 is a flowchart detailing a secondary process that is followed by the present invention.

FIG. 5 is a flowchart detailing a secondary process that is followed by the present invention.

FIG. 6 is a flowchart detailing a secondary process that is followed by the present invention.

FIG. 7 is a flowchart detailing a secondary process that is followed by the present invention.

FIG. 8 is a flowchart detailing a secondary process that is followed by the present invention.

FIG. 9 is a flowchart detailing a secondary process that is followed by the present invention.

FIG. 10 is a flowchart detailing a secondary process that is followed by the present invention.

### DETAIL DESCRIPTIONS OF THE INVENTION

All illustrations of the drawings are for the purpose of describing selected versions of the present invention and are not intended to limit the scope of the present invention.

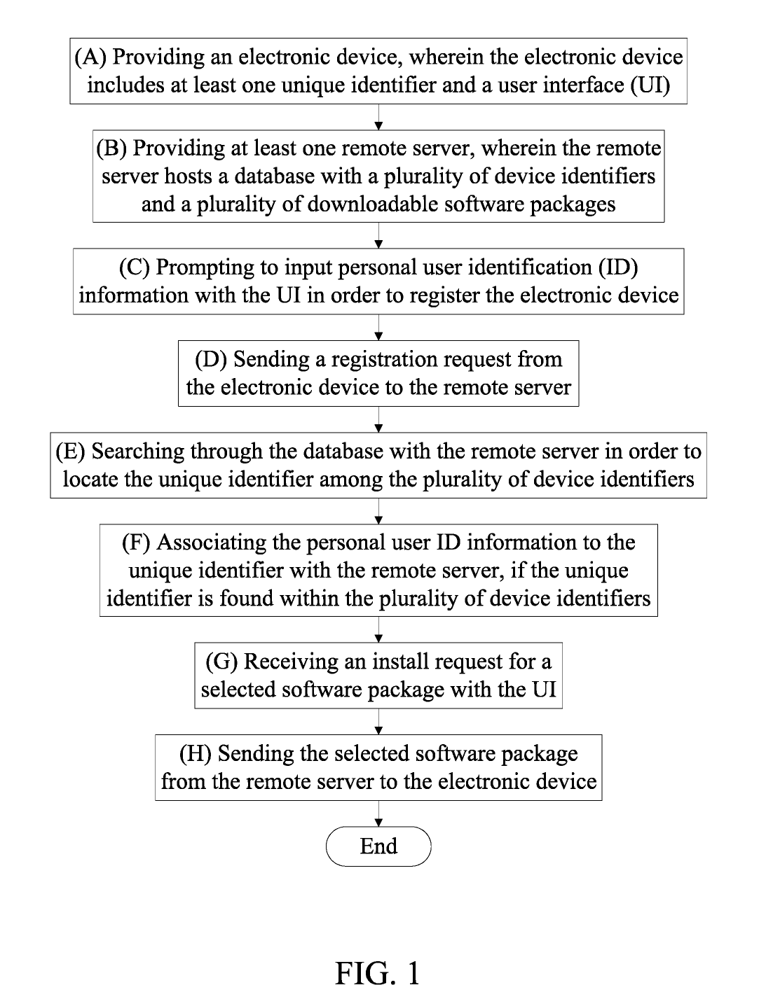

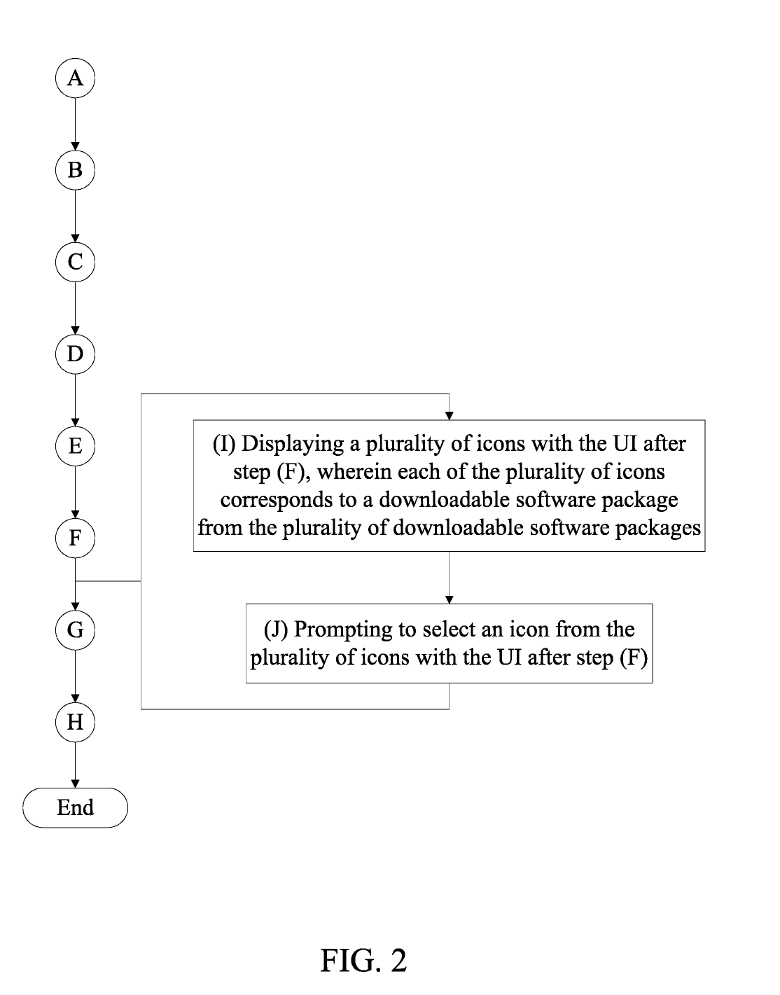

The present invention is a method for configuring and managing software for an electronic device. The overall process that is followed by the present invention is shown in FIG. 1 while secondary processes that are followed by the present invention are shown in FIGS. 2-10.

With reference to FIG. 1, an electronic device is provided (Step A). The electronic device may be any device that utilizes downloadable software and includes at least one unique identifier and a user interface (UI). The unique identifier is solely associated with the electronic device and the user interface is utilized by a user to interact with the electronic device as well as to input commands and receive feedback from the electronic device. At least one remote server is provided as well (Step B). The remote server hosts a database with a plurality of device identifiers and a plurality of downloadable software packages. The plurality of device identifiers correlates to multiple electronic devices and the plurality of downloadable software packages may be utilized by the electronic device.

With continued reference to FIG. 1, the user is prompted to input personal user identification (ID) information with the UI in order to register the electronic device (Step C). The personal user ID information may include, but is not limited to, the user's name, address, and contact information. The personal user ID information is utilized to associate the user with the electronic device during registration. A registration request is sent from the electronic device to the remote server in order to register the electronic device with the remote server (Step D). After the registration request has been sent to the remote server, the database is searched through with the remote server in order to locate the unique identifier among the plurality of device identifiers (Step E). The unique identifier is located among the plurality of device identifiers in order to ensure that the electronic device is authentic (e.g. authentically manufactured). The personal user ID information is associated to the unique identifier with the remote server if the unique identifier is found within the plurality of device identifiers (Step F). The electronic device is thus registered to the user on the database. After registration has been completed, an install request is received for a selected software package with the UI (Step G). The selected software package may include firmware and other types of software for the electronic device.

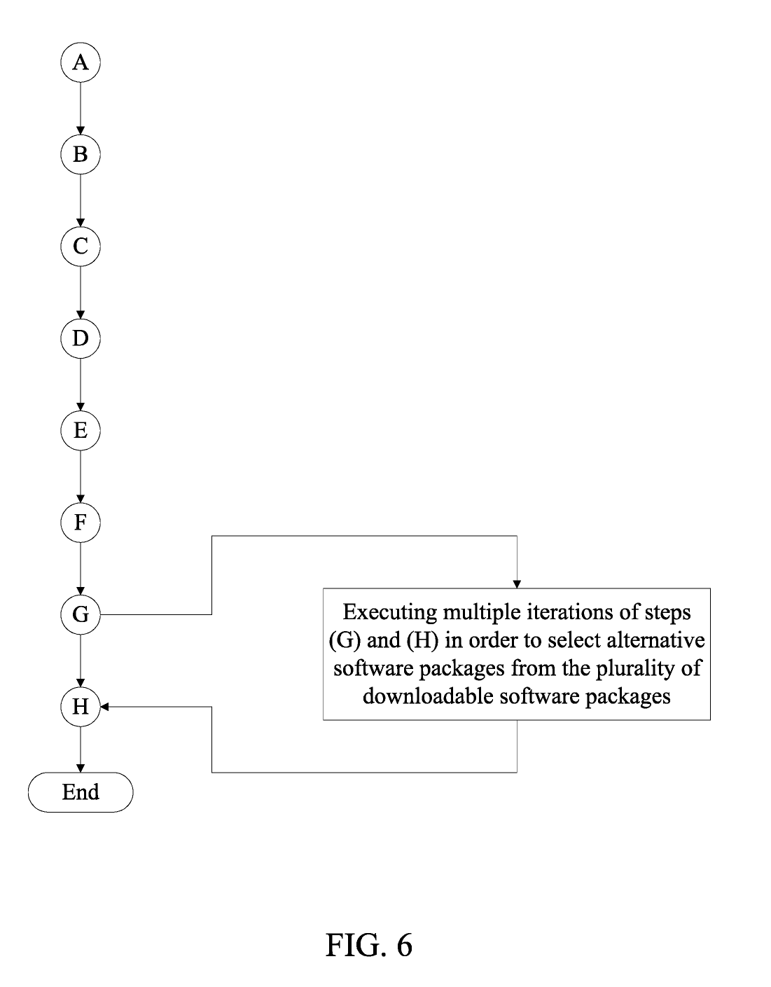

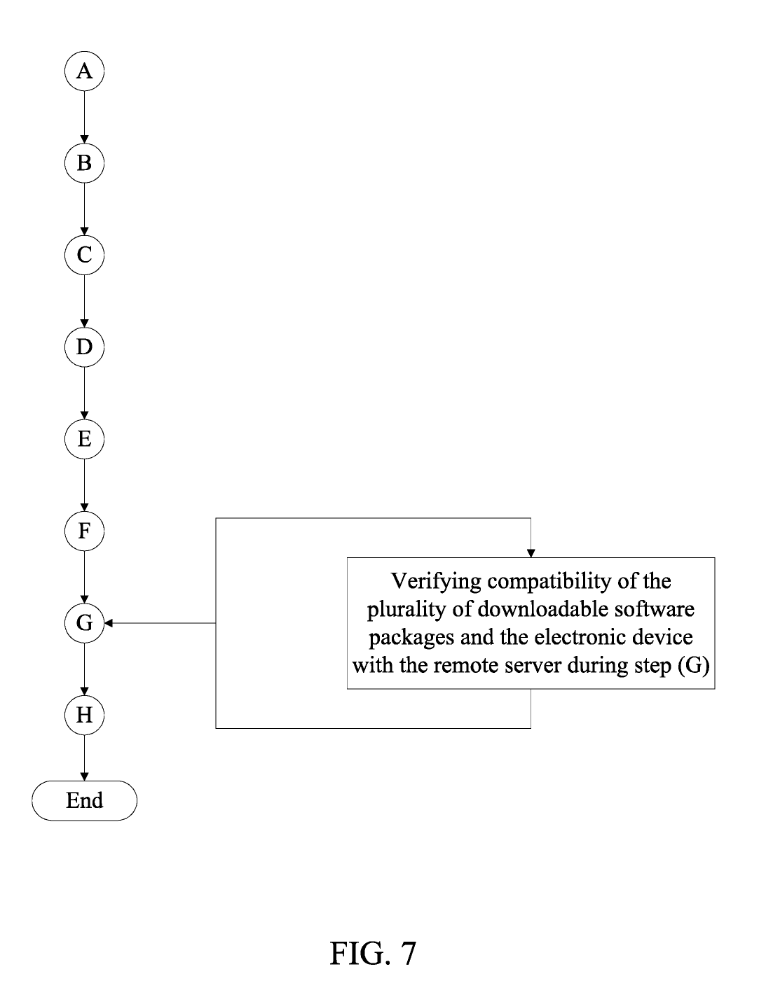

As shown in the sub-process for the method of the present invention shown in FIG. 7, the compatibility of the plurality of downloadable software packages and the electronic device is verified with the remote server before step (G). This ensures that the plurality of downloadable software packages is suitable for use with the electronic device. The selected software package is sent from the remote server to the electronic device (Step H). With reference to the sub-process for the method of the present invention shown in FIG. 6, multiple iterations of steps (G) and (H) are executed in order to select alternative software packages from the plurality of downloadable software packages. For example, the user may select from the plurality of downloadable software packages if the user no longer wishes to use the selected software package.

With reference to FIG. 2, a sub-process for the method of the present invention is shown. A plurality of icons is displayed with the UI after step (F) (Step I). Each of the plurality of icons corresponds to a downloadable software package from the plurality of downloadable software packages, displaying all available software packages for use with the electronic device. The user is prompted to select an icon from the plurality of icons with the UI after step (F) (Step J) in order to download the downloadable software package corresponding to the icon.

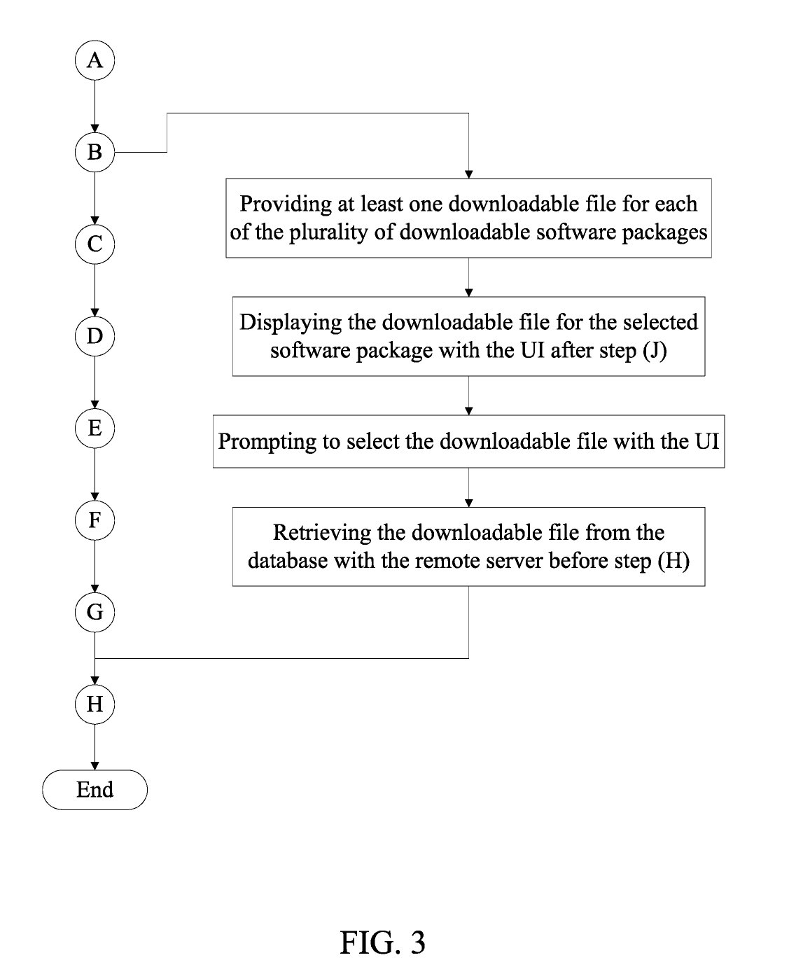

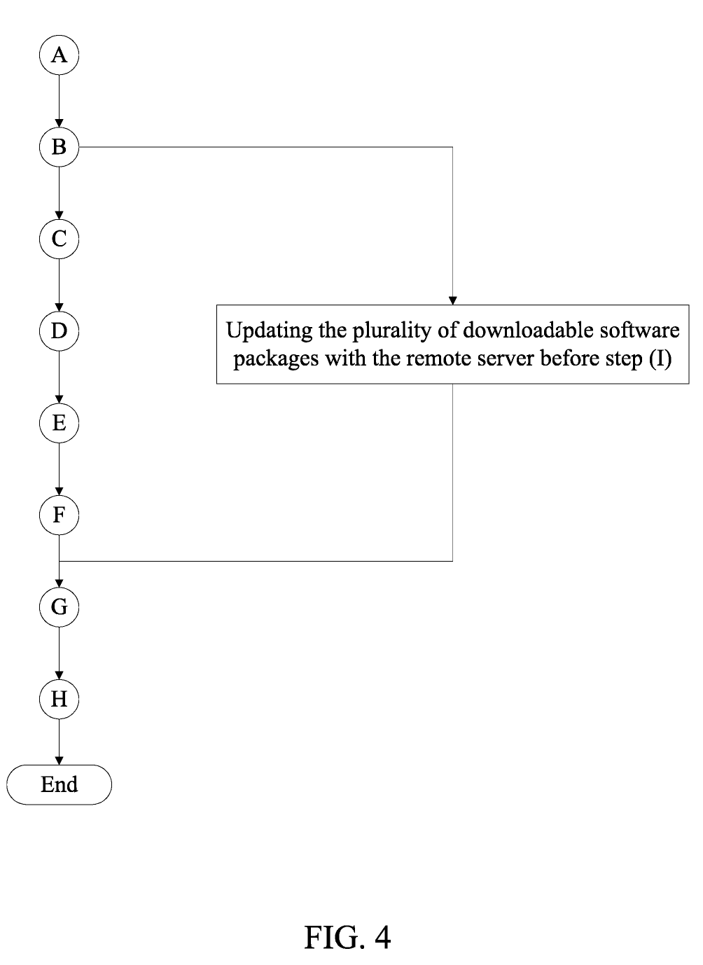

With further reference to FIG. 2 and with reference to FIG. 3, a sub-process for the method of the present invention is shown. At least one downloadable file for each of the plurality of downloadable software packages is provided. As previously mentioned, the downloadable file may include firmware or other types of software. The downloadable file for the selected software package is displayed with the UI after step (J), allowing the user to view the contents of each of the plurality of downloadable software packages. The user is prompted to select the downloadable file with the UI in order to begin the download process. The downloadable file is retrieved from the database with the remote server before step (H) for processing. With reference to the sub-process for the method of the present invention shown in FIG. 4, the plurality of downloadable software packages is updated with the remote server before step (I) in order to ensure that the user is downloading the latest version for each of the plurality of downloadable software packages.

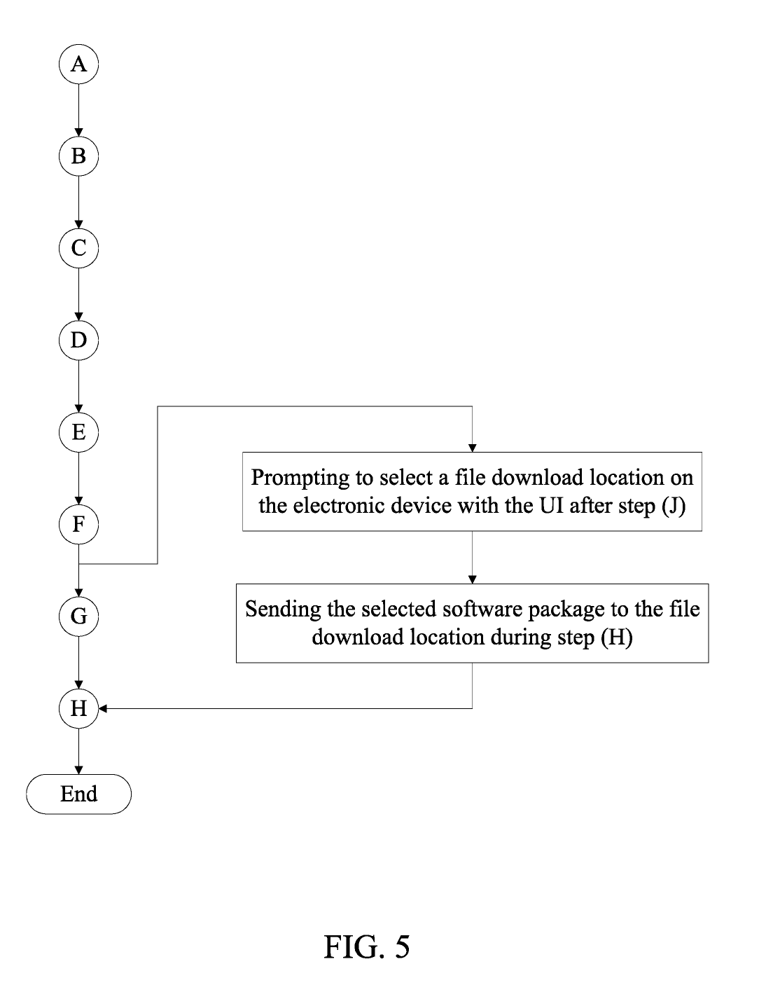

An additional sub-process for the method of the present invention is shown in FIG. 5. The user is prompted to select a file download location on the electronic device with the UI after step (J), allowing the user to easily locate and use the downloadable software package. The selected software package is sent to the file download location during step (H) for selection by the user. The file download location may be a sector on a hard disk drive or similar storage device for the electronic device.

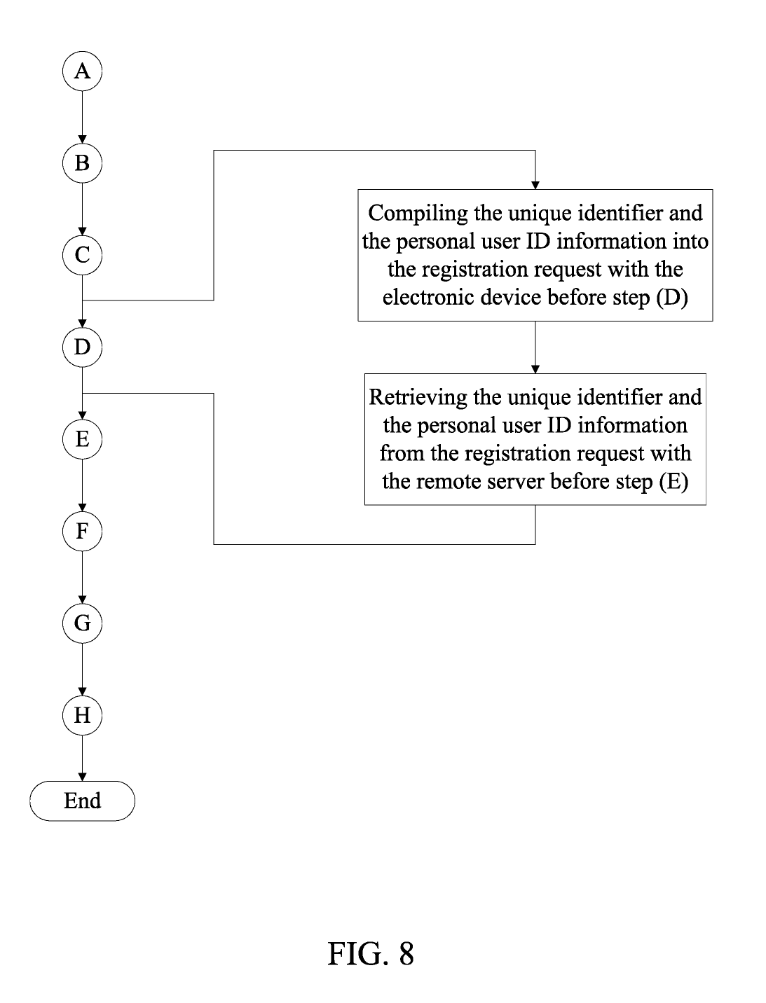

With reference to the sub-process for the method of the present invention shown in FIG. 8, the unique identifier and the personal user ID information are compiled into the registration request with the electronic device during step (D). As a result, the personal user ID information may be associated with the unique identifier and the electronic device during the registration process. The unique identifier and the personal user ID information are retrieved from the registration request with the remote server before step (E). The remote server may thus search for the unique identifier among the plurality of device identifiers on the database.

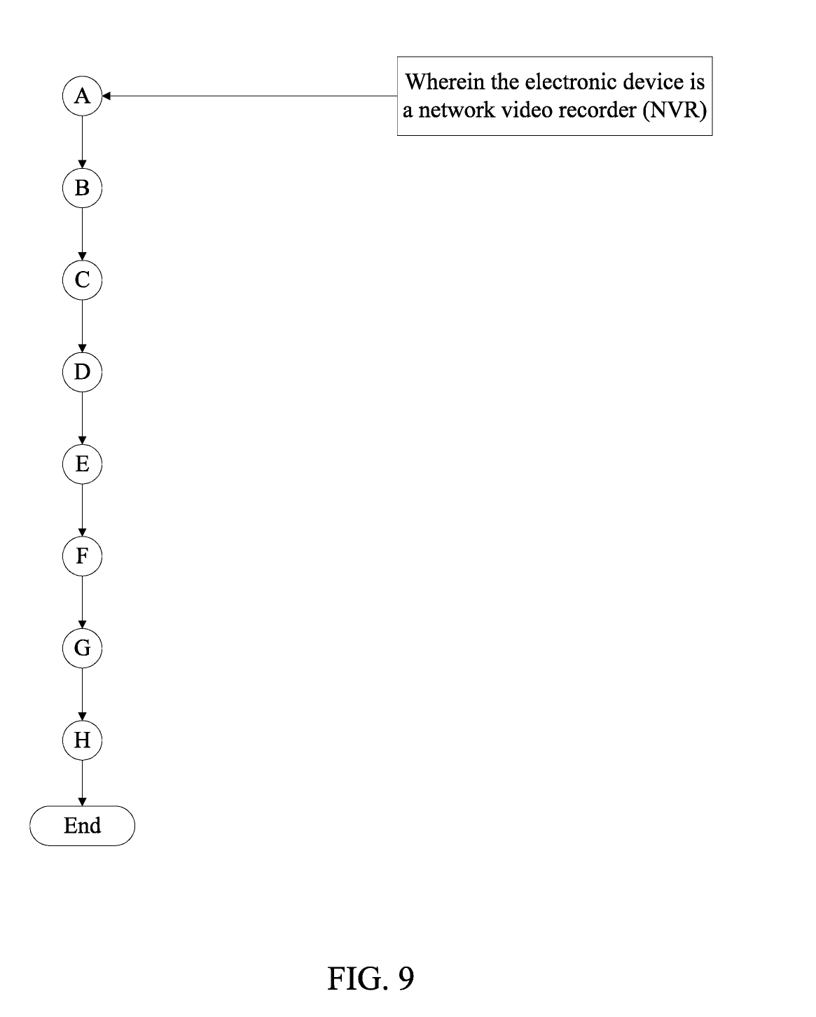

With reference to FIG. 9, in the preferred embodiment of the present invention, the electronic device is a network video recorder (NVR). The network video recorder is able to record video in a digital format. The video footage recorded by the network video recorder is saved to a disk drive or similar storage device. In the case of a network video recorder, the plurality of downloadable software packages includes video management software (VMS). When downloaded to the NVR, the VMS is used to manage video footage files and additionally provides the UI through which the user is able to interact with the NVR.

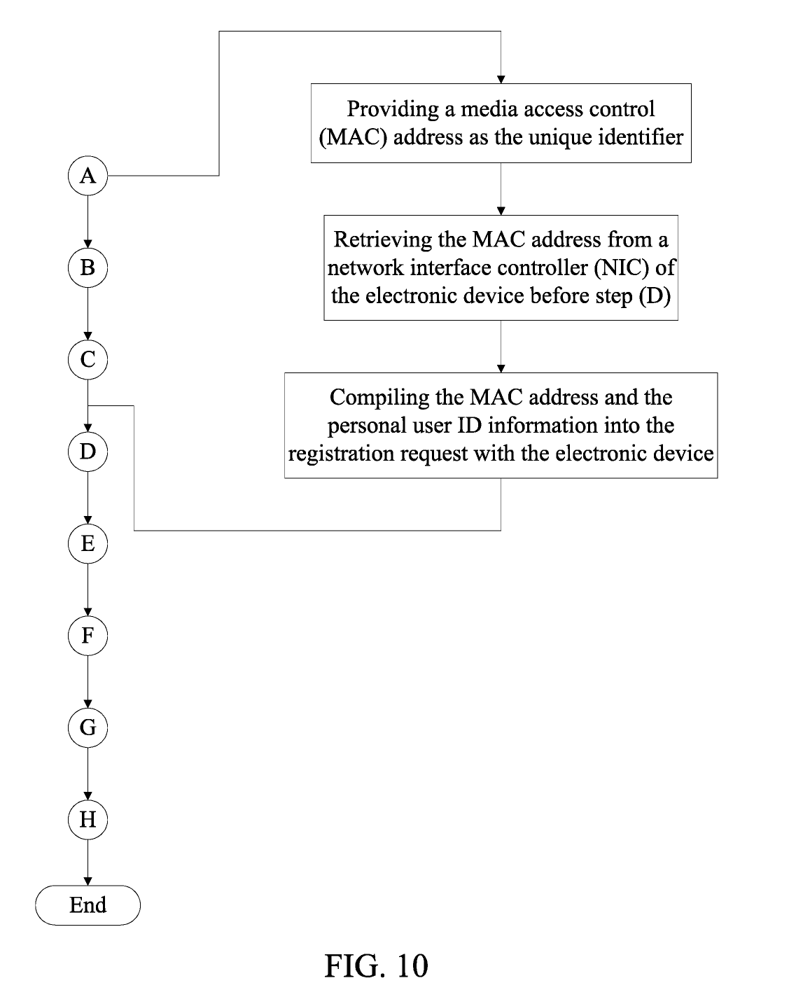

An additional sub-process for the method of the present invention is shown in FIG. 10. A media access control (MAC) address is provided as the unique identifier. The MAC address is stored on and associated with the electronic device. The MAC address is retrieved from a network interface controller (NIC) of the electronic device before step (D). The NIC is used to connect the electronic device to the Internet or another computer network. The electronic device may include one or more NICs with each NIC having a unique MAC address. The MAC address and the personal user ID information are compiled into the registration request with the electronic device. As a result, the personal user ID information is associated with the electronic device via the MAC address during the registration process.

Although the present invention has been explained in relation to its preferred embodiment, it is understood that many other possible modifications and variations can be made without departing from the spirit and scope of the present invention as hereinafter claimed.

What is claimed is:

1. A method for configuring and managing software for an electronic device, the method comprises the steps of:
(A) providing an electronic device, wherein the electronic device includes at least one unique identifier and a user interface (UI);
(B) providing at least one remote server, wherein the remote server hosts a database with a plurality of device identifiers and a plurality of downloadable software packages;
(C) prompting to input personal user identification (ID) information with the UI in order to register the electronic device;
(D) sending a registration request from the electronic device to the remote server;
(E) searching through the database with the remote server in order to locate the unique identifier among the plurality of device identifiers;
(F) associating the personal user ID information to the unique identifier with the remote server,
if the unique identifier is found within the plurality of device identifiers;
(G) receiving an install request for a selected software package with the UI; and
(H) sending the selected software package from the remote server to the electronic device.

2. The method for configuring and managing software for an electronic device as claimed in claim 1, the method comprises the steps of:
(I) displaying a plurality of icons with the UI after step (F), wherein each of the plurality of icons corresponds to a downloadable software package from the plurality of downloadable software packages; and
(J) prompting to select an icon from the plurality of icons with the UI after step (F).

3. The method for configuring and managing software for an electronic device as claimed in claim 2, the method comprises the steps of:
providing at least one downloadable file for each of the plurality of downloadable software packages;
displaying the downloadable file for the selected software package with the UI after step (J);
prompting to select the downloadable file with the UI; and
retrieving the downloadable file from the database with the remote server before step (H).

4. The method for configuring and managing software for an electronic device as claimed in claim 2, the method comprises the steps of:
updating the plurality of downloadable software packages with the remote server before step (I).

5. The method for configuring and managing software for an electronic device as claimed in claim 2, the method comprises the steps of:
prompting to select a file download location on the electronic device with the UI after step (J); and
sending the selected software package to the file download location during step (H).

6. The method for configuring and managing software for an electronic device as claimed in claim 1, the method comprises the steps of:
executing multiple iterations of steps (G) and (H) in order to select alternative software packages from the plurality of downloadable software packages.

7. The method for configuring and managing software for an electronic device as claimed in claim 1, the method comprises the steps of:
verifying compatibility of the plurality of downloadable software packages and the electronic device with the remote server before step (G).

8. The method for configuring and managing software for an electronic device as claimed in claim 1, the method comprises the steps of:
compiling the unique identifier and the personal user ID information into the registration request with the electronic device before step (D); and
retrieving the unique identifier and the personal user ID information from the registration request with the remote server before step (E).

9. The method for configuring and managing software for an electronic device as claimed in claim 1, wherein the electronic device is a network video recorder (NVR).

10. The method for configuring and managing software for an electronic device as claimed in claim 9, the method comprises the steps of:
providing a media access control (MAC) address as the unique identifier;
retrieving the MAC address from a network interface controller (NIC) of the electronic device before step (D); and
compiling the MAC address and the personal user ID information into the registration request with the electronic device.
